(19) United States
(12) Patent Application Publication
(10) Pub. No.: US 2006/0130137 A1
(43) Pub. Date: Jun. 15, 2006

(54) Method for preventing data corruption due to improper storage controller connections

(75) Inventors: Paul Wewel, Broomfield, CO (US); Mark Briel, Louisville, CO (US)

Correspondence Address: Timothy R. Schulte;Storage Technology Corporation, One StorageTek Drive, Louisville, CO, 80028-4309, US

(73) Assignee: Storage Technology Corporation

(21) Appl. No.: 11/010,026

(22) Filed: Dec. 10, 2004

(51) Int. Cl. G06F 12/14

(52) U.S. Cl. 726/17

(57) ABSTRACT

A method is provided for regulating access to a data storage configuration that includes a storage controller, a number of disk storage drives usefully configured as a RAID array, and a backend bus connected between the storage controller and the drives. One or more backend expansion ports are also connected to the backend bus, for use in expanding storage capacity as required. In accordance with the method, if a host device is inadvertently connected to a backend expansion port, rather than to an intended host connection port, an algorithm is implemented, preferably in a backend processor connected between the backend bus and the drives. The WWN of the host, received during a login procedure, is examined to determine whether or not the host is an authorized user of the storage configuration. If not, the backend processor is operated to prevent the host from accessing the drives, to prevent corruption of stored data.

### BACKGROUND OF THE INVENTION

1. Field of the Invention

The invention disclosed and claimed herein generally relates to a data storage configuration that includes a storage controller having both host device access ports, and one or more backend expansion ports. More particularly, the invention pertains to a method for preventing data corruption in a configuration of the above type, when an erroneous or otherwise improper connection is made.

2. Background of the Invention

In a common data storage configuration, a storage controller is provided with a backend bus for connecting the storage controller to storage media comprising an enclosure of hard disk drives, configured as a RAID array or the like. The storage controller is further provided with a number of host connection ports, for use by host PCs or workstations. These ports enable an authorized host to connect to the storage controller, and to thereby gain access to the storage drives to read data from or write data into the drives. The storage controller is configured to ensure that only authorized hosts are allowed access to the storage drives.

In addition to the host ports, the storage controller is typically furnished with expansion port connections. The expansion ports allow additional storage drives to be connected to the storage controller through the backend bus. This enables available storage capacity to be readily expanded, when required. In a common arrangement, host ports and expansion ports are included in the same interface device and on the same chasis. Thus, sets of host port terminals and expansion port terminals are mounted on the same user accessible panel of the interface. Moreover, the same type of connector used to make connections with the host ports can also be used to establish connections with the expansion ports.

The above arrangement of host and expansion ports provides a measure of convenience and efficiency. However, at present the expansion ports are generally connected to the storage drives through the backend bus of the controller, and in some configurations also through a backend protocol converter processor. As a result, a user host that is connected by mistake to an expansion port, rather than to an intended host port, could have direct access to writing the storage drives. If the host engaged in writing to the drives, data therein would become corrupted, due to the metadata and striping that occurs with disk controllers. Since the storage controller has been effectively bypassed in this situtation, it is without knowledge of the data corruption. Moreover, as controller electronics progressively shrink in size, the host and expansion port terminals become closer together. Accordingly, plugging into the wrong port, which can result in catastrophic data loss, becomes more and more likely, notwithstanding labels and warnings.

### SUMMARY OF THE INVENTION

The invention generally utilizes the intelligence of backend devices, such as the processor of the backend protocol converter processor, to examine the identity of a connected host and to disallow access if the host is not identified as an allowed controller. This would prevent the disallowed host from corrupting customer data or controller metadata on the backend storage devices. In the event that there is no backend processor in the storage configuration, access may be prevented by opening the port interface, if a foreign device is detected on a bus to which it should not be connected. In one useful embodiment, the invention is directed to a method for regulating access to specified data storage drives in a configuration wherein a backend bus connected between a storage controller and the specified drives is also connected to one or more backend ports. The method comprises the steps of detecting connection of a host device to one of the backend ports, and determining whether or not the detected host is authorized to access the storage drives, on the basis of specified information supplied by the detected host. The host is prohibited from accessing the storage drives, if it is determined that the host is not authorized to do so, and otherwise the detected host is allowed to access the storage drives.

### BRIEF DESCRIPTION OF THE DRAWINGS

The novel features believed characteristic of the invention are set forth in the appended claims. The invention itself, however, as well as a preferred mode of use and further objectives and advantages thereof, will best be understood by reference to the following detailed description of an illustrative embodiment when read in conjunction with the accompanying drawings, wherein:

FIG. 1 is a block diagram showing a data storage configuration including a storage controller in which an embodiment of the invention may be implemented.

FIG. 2 is a schematic diagram showing a panel of an interface device which may be used with the storage controller of FIG. 1.

FIG. 3 is a flowchart illustrating an embodiment of the invention.

FIG. 4 is a block diagram showing a simplified configuration of components for implementing an embodiment of the invention.

### DETAILED DESCRIPTION OF THE PREFERRED EMBODIMENT

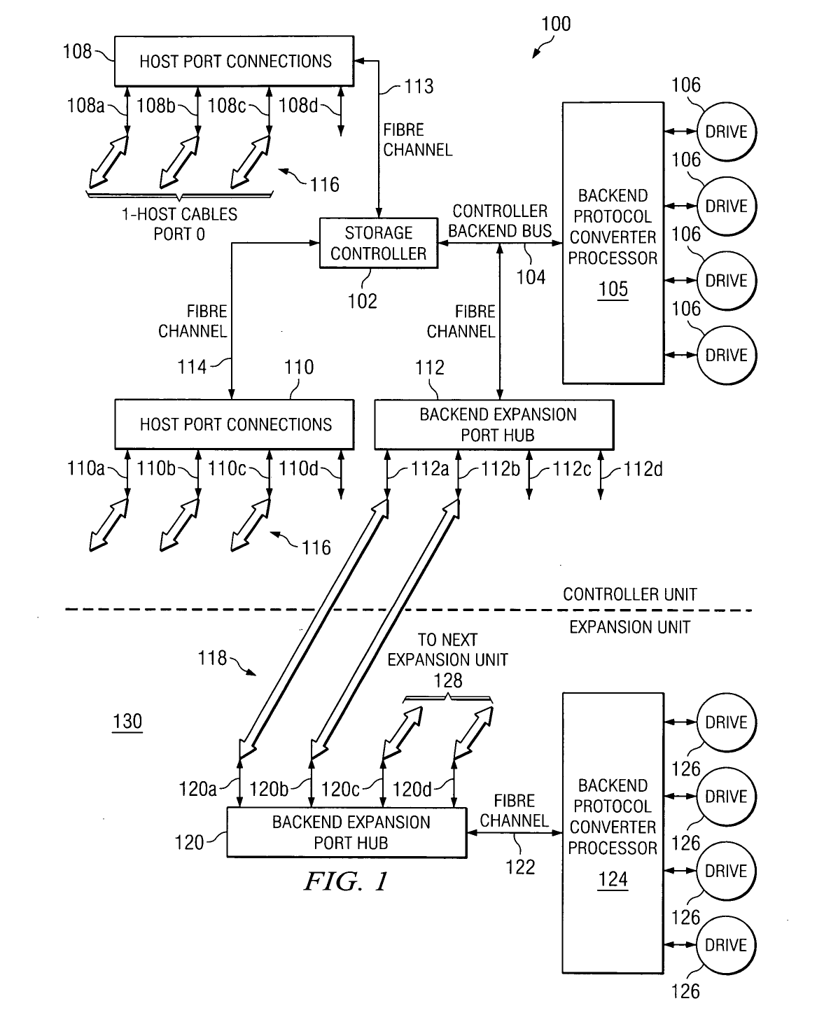

Referring to FIG. 1, there is shown a data storage configuration 100 that includes a storage controller 102. Storage controller 102 is connected through a backend bus 104 and a backend protocol converter processor 105 to a set or enclosure of hard disk storage drives 106. The processor 105 is provided to handle any protocol conversion required in data storage or retrieval. Drives 106 are usefully configured as a Redundant Array of Independent Disks (RAID). In a RAID array, data is written to multiple disks.

Storage controller 102 is further connected to host port connection components 108 and 110, by means of fibre channels 113 and 114, respectively. Each of the host port connection components is provided with host port terminals 108 a-d and 110 a-d, respectively, for use in establishing connections between host ports and host cables 116, which are coupled to host devices such as workstations, PCs and the like (not shown). A host connected to a host port terminal is placed in communication with storage controller 102.

When a connection is initially established between a host and storage controller 102, the host bus adapter (HBA) of the host must furnish the storage controller with the World Wide Name (WWN) that uniquely identifies the connected host. This is generally accomplished during a login procedure. Storage controller 102 is provided with a list showing the WWNs of all users, on a worldwide basis, that are entitled to access data on drives 106 of storage configuration 100. If the WWN of a connected host is on the list, the host will be permitted to access the drives 106. Otherwise, the connected host will not be allowed to do so.

Referring further to FIG. 1, there are shown terminals 112a and 112b of backend expansion port hub 112 coupled by means of expansion cables 118 to terminals 120a and 120b, respectively, of a backend expansion port hub 120. Expansion port hub 120 is shown connected through a fibre channel 122 and backend protocol converter processor 124 to a set of data storage drives 126. Thus, by means of backend expansion port hubs such as 112 and 120, the storage capacity available to storage controller 102 and to host users of storage configuration 100 may be very quickly and efficiently expanded. The backend expansion port hub 120, processor 124 and drives 126 collectively comprise an expansion unit 130. Expansion cables 128, connected to terminals 120c and 120d of backend expansion port hub 120, could be coupled to a further expansion unit (not shown) if desired.

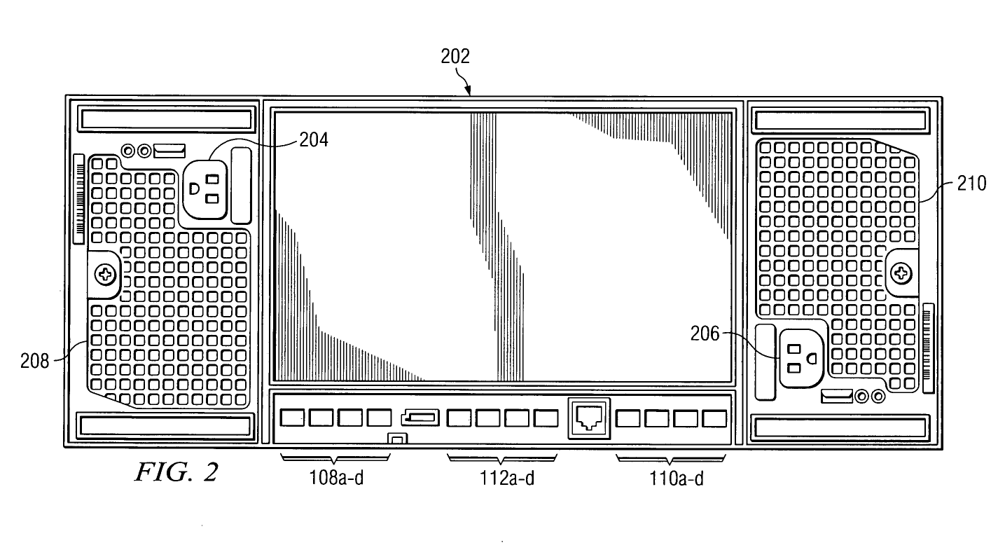

In a typical arrangement, the storage controller 102, host port connection components 108 and 110, and backend expansion port hub 112 are all mounted on a common controller/expansion chassis. Moreover, for convenience respective host port terminals such as 108a-d and 110a-d, as well as expansion port terminals 112a-d, are all mounted on a common panel of the chassis. Referring to FIG. 2, there is shown a controller chassis panel 202, wherein the host port terminals 108a-d and 110a-d are mounted in close proximity to the expansion port terminals 112a-d. Expansion port terminals 112a-d, in fact, are positioned between the host port terminal sets 108a-d and 110a-d. FIG. 2 further shows power connectors 204 and 206 and vent screens 208 and 210 of panel 202, but does not show any other components thereof for simplicity.

A connector known as an optical SFP and optical cable is commonly used to establish connections with host port terminals such as 108a-d and 110a-d. However, this type of connector will also mate with expansion terminals 112a-d, to form connections therewith. Because of the close spacing of the host port terminals and expansion port terminals, it is very easy to connect a host to a backend expansion port 112a-d by mistake, as described above. This could result in substantial corruption of data in the storage drives, as likewise described.

As previously described, a backend protocol converter processor 105 is in place between backend bus 104 and storage drives 106. In accordance with an embodiment of the invention, an algorithm is implemented in backend processor 105 that disallows reads and writes to the drives 106, or to drives in any connected expansion enclosures, if the device attempting the access is not authorized. The backend processor 105 uses the WWN of the host device attempting access to determine whether or not access should be allowed. More particularly, when a host device connected to any of the terminals of backend expansion port 112 engages in the login procedure referred to above, the connected host furnishes its WWN. The intelligence capability available in the backend processor 105 implements the algorithm, to examine the WWN provided by the host device. If the WWN is not on the storage controller authorization list referred to above, access to the storage drivers is prohibited. Thus, the backend processor 105 will allow access only if the WWN of the host connected to the backend port 112 is found on the list, indicating the host to be an authorized controller.

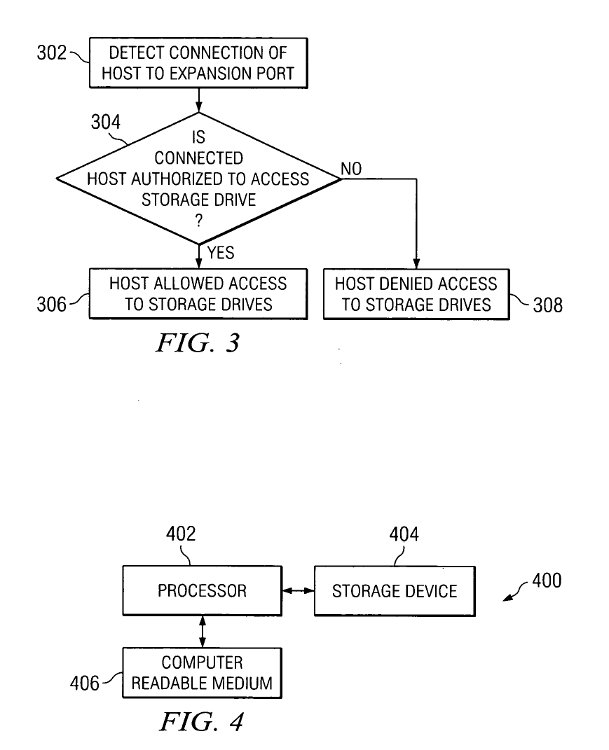

Referring to FIG. 3, there is shown a flowchart illustrating respective steps carried out by the algorithm implemented in backend processor 105. At function block 302, connection of a host device to terminals 112a-d is detected. When this occurs, backend processor 105 operates, as indicated by decision block 304, to determine whether or not the host is authorized to access the storage drives of configuration 100. If the host is authorized, it is allowed to access storage drives 106, as indicated by function block 306. However, if the host connected to the backend port is identified by its WWN to not be an authorized user, it is prohibited from accessing storage drives 106, as indicated by function block 308.

If a host is connected to backend processor 105 by means of terminal 120a-b of expansion hub 120, or by means of any other backend expansion hub, processor 105 will operate to apply the steps shown in FIG. 3 to such host. Thus, drives 106 will be protected from unauthorized access by hosts using any backend port hub connected to processor 105.

Moreover, the backend processor of each expansion unit, such as backend processor 124 of expansion unit 130, must also protect its drives from unauthorized access. For example, hosts could be connected to processor 124 through either terminals 112a-d or 120a-d. Accordingly, the algorithm described above in connection with backend processor 105 is also implemented in processor 124, as well as in the backend processor of any other expansion unit connected to storage controller 102. Thus, processor 124 is operated in accordance with the same procedures described herein for processor 105, to prevent unauthorized access to respective storage drives thereof.

Referring to FIG. 4, there is shown a simplified processing system for implementing an embodiment of the invention. System 400 generally comprises a processor 402, a storage device 404, and a computer readable medium 406. The processor usefully 402 comprises the backend protocol converter processor 105, but it may be another backend processor device as well.

In the event that neither processor 105 nor any other backend processor is included in the storage configuration, an embodiment of the invention would implement the above algorithm in a processor contained in storage controller 102. Thus, the storage controller would detect connection of a host to backend expansion port hub 112, and would examine the WWN of the connected host. If the host was found to be unauthorized to have driver access, storage controller 102 would configure backend port hub 112 to prevent the detected host device from having access to the storage drives through the hub.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. In a data storage configuration wherein a backend bus connected between a storage controller and specified data storage drives is also connected to one or more backend ports, a method for regulating access to said data storage drives comprising the steps of:
detecting connection of a host device to one of said backend ports;
determining from specified information supplied by said detected host whether or not said detected host is authorized to access said storage drives;
prohibiting said detected host from accessing said storage drives upon determining that said detected host is not authorized to do so; and
allowing said detected host to access said storage drives upon determining that said detected host is authorized to do so.

2. The method of claim 1, wherein:
respective steps of said method are implemented by a specified algorithm in a processor device positioned between said backend bus and said storage drives.

3. The method of claim 1, wherein:
said specified information supplied by said detected host comprises the WWN of said host.

4. The method of claim 3, wherein:
said step of determining host authorization comprises determining whether or not the WWN supplied by said detected host is found on a list of authorized WWNs contained in said storage controller.

5. The method of claim 2, wherein:
said data storage configuration includes a number of host connection ports for enabling a host device to establish connections with said storage controller, and said backend ports are physically located in close proximity to said host connection ports.

6. The method of claim 2, wherein:
said backend processor comprises a backend protocol converter processor, and said specified data storage drives respectively comprise hard disk storage drives configured in a RAID array.

7. The method of claim 2, wherein:
said backend ports are respectively adapted for use in connecting a data storage expansion unit to said storage controller.

8. The method of claim 1, wherein:
said detected host is prohibited from accessing said storage devices by rendering an interface coupled between said backend ports and said storage drives impassable to said detected host device.

9. The method of claim 1, wherein:
said interface comprises a backend expansion port hub, and said storage controller configures said hub to prevent said detected host device from having access to said storage drives through said hub.

10. A computer program product in a data storage configuration for regulating access to specified data storage drives, wherein a backend bus connected between a storage controller and the specified data storage drives is also connected to one or more backend ports, said computers program product comprising:
first instructions for detecting connection of a host device to one of said backend ports;
second instructions for determining from specified information supplied by said detected host whether or not said detected host is authorized to access said storage drives;
third instructions for prohibiting said detected host from accessing said storage drives upon determining that said detected host is not authorized to do so; and
fourth instructions for allowing said detected host to access said storage drives upon determining that said detected host is authorized to do so.

11. The computer program product of claim 10, wherein:
respective steps of said method are implemented by a specified algorithm in a processor device positioned between said backend bus and said storage drives.

12. The computer program product of claim 10, wherein:
said specified information supplied by said detected host comprises the WWN of said host.

13. The computer program product of claim 12, wherein:
determination of host authorization comprises determining whether or not the WWN supplied by said detected host is found on a list of authorized WWNs contained in said storage controller.

14. The computer program product of claim 10, wherein:
said data storage configuration includes a number of host connection ports for enabling a host device to establish connections with said storage controller, and said backend ports are physically located in close proximity to said host connection ports.

15. The computer program product of claim 10, wherein:
said backend ports are respectively adapted for use in connecting a data storage expansion unit to said storage controller.

16. In a data storage configuration wherein a backend bus connected between a storage controller and specified data storage drives is also connected to one or more backend ports, a computer system compromising:
a processor; and
a computer readable medium connected to said processor, said medium configured to be read by said processor and to thereby cause said processor to:
detect connection of a host device to one of said backend ports;
determine from specified information supplied by said detected host whether or not said detected host is authorized to access said storage drives;
prohibit said detected host from accessing said storage drives upon determining that said detected host is not authorized to do so; and
allow said detected host to access said storage drives upon determining that said detected host is authorized to do so.

17. The system of claim 16, wherein:
said processor is positioned between said backend bus and said storage drives, and operates in accordance with a specified algorithm implemented in said processor.

18. The system of claim 16, wherein:
said specified information supplied by said detected host comprises the WWN of said host.

19. The system of claim 18, wherein:
authorization of said detected host is determined by determining whether or not the WWN supplied by said detected host is found on a list of authorized WWNs contained in said storage controller.

20. The system of claim 17, wherein:
said data storage configuration includes a number of host connection ports for enabling a host device to establish connections with said storage controller, and said backend ports are physically located in close proximity to said host connection ports.
